(19) United States
(12) Patent Application Publication
(10) Pub. No.: US 2008/0252773 A1
(43) Pub. Date: Oct. 16, 2008

(54) IMAGE PICKUP APPARATUS, FOCUSING CONTROL METHOD AND PRINCIPAL OBJECT DETECTING METHOD

(75) Inventor: Hiroyuki Oishi, Kurokawa-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/100,195

(22) Filed: Apr. 9, 2008

(30) Foreign Application Priority Data
Apr. 11, 2007 (JP) 2007-104092

(51) Int. Cl. H04N 5/232; G03B 13/32

(52) U.S. Cl. 348/347; 396/125; 348/E05.042

(57) ABSTRACT

In a digital still camera, an image is picked up by detecting object light from a lens system having a focus lens. A region of a human face is detected within the image by image analysis thereof. An estimated distance of the facial region is determined according to a size of the facial region. A lens moving distance of the focus lens is determined according to the estimated distance. A contrast value of the image is acquired in moving the focus lens by the lens moving distance. An in-focus lens position is determined according to the contrast value, to set the focus lens in the in-focus lens position. Furthermore, before the image pickup step, so great an aperture value of the lens system on the optical path is set as to enable image pickup of the facial region within a depth of field.

### BACKGROUND OF THE INVENTION

1. Field of the Invention

The present invention relates to an image pickup apparatus, focusing control method and principal object detecting method. More particularly, the present invention relates to an image pickup apparatus and focusing control method in which intention of a user to photograph an image can be reflected well in a recorded image as a result, and principal object detecting method.

2. Description Related to the Prior Art

A digital still camera is known in the art, and includes an image pickup device for photoelectrically converting object light. An autofocus type of the digital still camera is widely used, and includes an autofocus device according to a contrast detection method.

Autofocus control of the contrast detection method includes steps of moving a focus lens on an optical axis, detecting a contrast value of an object image according to an image signal obtained by an image pickup device, determining a peak position with a peak of the contrast as an in-focus lens position, and moving and setting the focus lens so as to focus an object automatically. To detect the peak position, autofocus stepwise evaluation (autofocus search) of a hill climbing method is used. The contrast value or autofocus evaluation value is acquired stepwise at a predetermined moving amount of the focus lens, and is compared with that of a preceding step. The peak position is finally detected by continuing sampling in a direction of increasing the contrast value.

U.S. Pat. Pub. No. 2007/030381 (corresponding to JP-A 2006-201282) discloses the digital still camera in which a principal object or a face of a person is detected by analyzing an object image. An estimated distance of the object is obtained from the detected face, to determine a start position of the autofocus stepwise evaluation so as to shorten the time required for the autofocus stepwise evaluation. In the digital still camera, a moving range of the focus lens (range of the autofocus stepwise evaluation) can be made small if a face is detected. Time of the autofocus stepwise evaluation can be shortened.

U.S. Pat. Pub. No. 2005/270410 (corresponding to JP-A 2006-018246) discloses the digital still camera in which a start position of the autofocus stepwise evaluation and an interval of steps of the autofocus stepwise evaluation (amount of moving the focus lens) are determined when the estimated distance is obtained by the face detection. The interval of steps of the autofocus stepwise evaluation of the focus lens is made small in the vicinity of a position of the focus lens of focusing at the estimated distance. This is effective in shortening the time of the autofocus stepwise evaluation and raising precision in detection of autofocus control.

In face detection according to the known autofocus, an aperture value and sensitivity are determined according to brightness of an object. A depth of field of a scene (region of being in-focus) is determined according to the aperture value of the aperture stop mechanism. Failure is likely to occur in the face detection typically if there are plural persons or principal objects and if the face detection is attempted without sharply focusing on a person's face, because of smallness of the depth of field. In view of this, U.S. Pat. Pub. No. 2007/030381 (corresponding to JP-A 2006-201282) discloses a method in which the focus lens is moved and set in a position of a hyperfocal distance before the face detection, so as to raise reliability of the face detection. However, there is a shortcoming in that time required for the face detection is long considerably because time for moving the focus lens is required.

It is usual in the autofocus stepwise evaluation that the focus lens is moved from the closest focus with a nearest distance toward the infinity focus in order to prevent erroneous focusing on the background instead of the person. A shift of a focus position is small on the side of the close focus relative to a moving amount of the focus lens. There is a problem in that time is required for the autofocus stepwise evaluation until reach to a lens position of being in-focus on the person. In the known techniques of U.S. Pat. Pub. No. 2007/030381 (corresponding to JP-A 2006-201282) and U.S. Pat. Pub. No. 2005/270410 (corresponding to JP-A 2006-018246), the start point, and an interval and length of the evaluation steps are determined for the purpose of shortening time for the autofocus stepwise evaluation and quickening the autofocus control. However, there is a limit of quickening the autofocus control because of no consideration of a difference in the shift of the focus position relative to the moving amount of the focus lens between the closest focus and the infinity focus.

In the methods of U.S. Pat. Pub. No. 2007/030381 (corresponding to JP-A 2006-201282) and U.S. Pat. Pub. No. 2005/270410 (corresponding to JP-A 2006-018246), there is no detection of the focus position for the background, because the range of the autofocus stepwise evaluation is made small for the purpose of quickening the autofocus control. There is no suggestion of focusing both the person and background according to information obtained by the autofocus stepwise evaluation. Intention of a user is reflected only incompletely in the autofocus control.

### SUMMARY OF THE INVENTION

In view of the foregoing problems, an object of the present invention is to provide an image pickup apparatus and focusing control method in which intention of a user to photograph an image can be reflected well in a recorded image as a result, and principal object detecting method.

In order to achieve the above and other objects and advantages of this invention, an image pickup apparatus includes a lens system having a focus lens. An image sensor picks up an image formed by the lens system to generate an image signal by conversion. A detection unit detects a principal object by image analysis according to the image signal. A distance estimating unit determines an estimated distance of the principal object as viewed from the lens system according to a focal length of the lens system and an image size of the principal object. A moving distance determiner determines a lens moving distance of the focus lens from a lens position of infinity focus according to the estimated distance. A lens moving mechanism moves the focus lens by the lens moving distance in autofocus evaluation from the lens position of the infinity focus toward a lens position of close focus. A contrast acquisition unit acquires a contrast value of the image from the image signal for lens positions in moving the focus lens. A focusing control unit determines a lens position at a peak of the contrast value as in-focus lens position, to set the focus lens in the in-focus lens position.

In a preferred embodiment, the principal object is a human face.

Furthermore, a corrector corrects the estimated distance with a distance error created in estimation in the distance estimating unit, to determine the lens moving distance.

If a plurality of principal objects are detected by the detection unit, the distance estimating unit determines the estimated distance to one of the principal objects with a largest size.

Furthermore, an aperture stop mechanism is disposed on an optical axis of the lens system. An aperture stop adjuster sets an aperture value of the aperture stop mechanism to enlarge a depth of field in detection of the principal object with the detection unit.

Furthermore, a sensitivity adjuster sets ISO sensitivity of imaging according to a difference of the aperture value from an aperture value for optimizing an exposure.

If the contrast value comes to a peak in plural lens positions of the focus lens, the focusing control unit determines one of the lens positions nearer to the lens position of the close focus as the in-focus lens position.

In one preferred embodiment, furthermore, an aperture stop mechanism is disposed on an optical axis of the lens system. An object distance detector determines a principal object distance and an auxiliary object distance according to first and second lens positions, the first lens position being associated with the principal object and defined at a peak of the contrast value in the lens moving distance, the second lens position being associated with an auxiliary object and defined at a peak of the contrast value on a side nearer to the lens position of the infinity focus than the first lens position. An aperture value acquisition unit acquires an aperture value of the aperture stop mechanism to cause the auxiliary object to fall within a depth of field when the focus lens is set in the first lens position for the in-focus lens position according to the principal and auxiliary object distances. An aperture stop adjuster adjusts the aperture stop mechanism according to the aperture value.

Furthermore, a sensitivity adjuster sets ISO sensitivity of imaging according to a difference of the aperture value from an aperture value for optimizing an exposure.

In another preferred embodiment, furthermore, an object distance detector determines a principal object distance and an auxiliary object distance according to first and second lens positions, the first lens position being associated with the principal object and defined at a peak of the contrast value in the lens moving distance, the second lens position being associated with an auxiliary object and defined at a peak of the contrast value on a side nearer to the lens position of the infinity focus than the first lens position. An in-focus position determiner determines a corrected lens position of the focus lens to cause the principal and auxiliary object distances to fall within a depth of field, wherein the focusing control unit sets the focus lens in the corrected lens position as the in-focus lens position.

If the lens moving distance is more than a half of a distance between the lens position of the infinity focus and the lens position of the close focus, the lens moving mechanism moves the focus lens from the lens position of the close focus toward the lens position of the infinity focus.

In one aspect of the invention, an image pickup apparatus includes a lens system for passing object light. An image pickup unit picks up an image by detecting the object light. A detection unit detects a principal object within the image by image analysis thereof. An aperture stop mechanism is disposed on an optical path of the object light traveling toward the image pickup unit. An aperture stop adjuster sets so great an aperture value of the aperture stop mechanism as to enable image pickup of the principal object within a depth of field.

Furthermore, a sensitivity adjuster sets sensitivity of imaging with the image pickup unit so high as to correspond to the aperture value set by the aperture stop adjuster.

In another aspect of the invention, a focusing control method includes a step of picking up an image formed by a lens system having a focus lens. A principal object is detected in the image by image analysis thereof. An estimated distance of the principal object as viewed from the lens system is determined according to an image size of the principal object. A lens moving distance of the focus lens is determined according to the estimated distance. The focus lens is moved by the lens moving distance in autofocus evaluation from a lens position of infinity focus toward a lens position of close focus. A contrast value of the image is acquired for lens positions in the autofocus evaluation. A lens position at a peak of the contrast value is determined as in-focus lens position, to set the focus lens in the in-focus lens position.

If a plurality of principal objects are detected, the estimated distance to one of the principal objects with a largest size is determined in the estimated distance determining step.

Furthermore, a principal object distance and an auxiliary object distance are determined according to first and second lens positions, the first lens position being associated with the principal object and defined at a peak of the contrast value in the lens moving distance, the second lens position being associated with an auxiliary object and defined at a peak of the contrast value on a side nearer to the lens position of the infinity focus than the first lens position. An aperture value of the aperture stop mechanism is acquired to cause the auxiliary object to fall within a depth of field when the focus lens is set in the first lens position for the in-focus lens position according to the principal and auxiliary object distances. The aperture stop mechanism is adjusted according to the aperture value.

Furthermore, a principal object distance and an auxiliary object distance are determined according to first and second lens positions, the first lens position being associated with the principal object and defined at a peak of the contrast value in the lens moving distance, the second lens position being associated with an auxiliary object and defined at a peak of the contrast value on a side nearer to the lens position of the infinity focus than the first lens position. A corrected lens position of the focus lens is determined to cause the principal and auxiliary object distances to fall within a depth of field, to set the focus lens in the corrected lens position as the in-focus lens position.

In another aspect of the invention, a principal object detecting method of detecting a principal object in an image is provided. Object light is detected from a lens system for forming the image. There is a step of setting so great an aperture value of the lens system on an optical path as to enable image pickup of the principal object within a depth of field.

Consequently, intention of a user to photograph an image can be reflected well in a recorded image as a result, because the autofocus control is carried out specifically according to acquired information of a principal object included in an object.

### BRIEF DESCRIPTION OF THE DRAWINGS

The above objects and advantages of the present invention will become more apparent from the following detailed description when read in connection with the accompanying drawings, in which:

FIG. 1 is a block diagram schematically illustrating a digital still camera;

FIG. 2 is a plan illustrating a method of detecting a facial region of a human face in an object image;

FIG. 3 is a graph illustrating a correlation of a position of a focus lens and a contrast value;

FIG. 4A is an explanatory view illustrating a state of changing a depth of field by changing an aperture value;

FIG. 4B is an explanatory view illustrating the same as FIG. 4A with a difference of being after stopping down;

FIG. 5 is a graph illustrating a correlation between a lens moving distance of the focus lens and focus adjustment;

FIG. 6 is a graph illustrating the ratio indicated in FIG. 5 stepwise for values of focal lengths;

FIG. 7 is a graph illustrating a contrast curve as correlation between a contrast value and a position of the focus lens;

FIG. 8 is a plan illustrating an object image where plural facial regions are present;

FIG. 9 is a graph illustrating a contrast curve obtained upon detecting the plural facial regions;

FIG. 10 is a flow chart illustrating autofocus control in the digital still camera;

FIG. 11 is a flow chart illustrating face detection in the autofocus control;

FIG. 12 is a block diagram schematically illustrating movement of the focus lens in the autofocus stepwise evaluation from the close focus to the infinity focus;

FIG. 13 is a block diagram schematically illustrating elements in the CPU in another preferred digital still camera;

FIG. 14 is an explanatory view illustrating a state of a background falling within a depth of field by stopping down;

FIG. 15 is a flow chart illustrating autofocus control in the digital still camera;

FIG. 16 is a block diagram schematically illustrating still another preferred digital still camera;

FIG. 17A is an explanatory view illustrating a state of a background falling within a depth of field by correction;

FIG. 17B is an explanatory view illustrating the same as FIG. 17A with a difference in the condition of L1<L2;

FIG. 18 is a graph illustrating a contrast curve in the condition of L1=L2;

FIG. 19 is a flow chart illustrating autofocus control in the digital still camera.

### DETAILED DESCRIPTION OF THE PREFERRED EMBODIMENT(S) OF THE PRESENT INVENTION

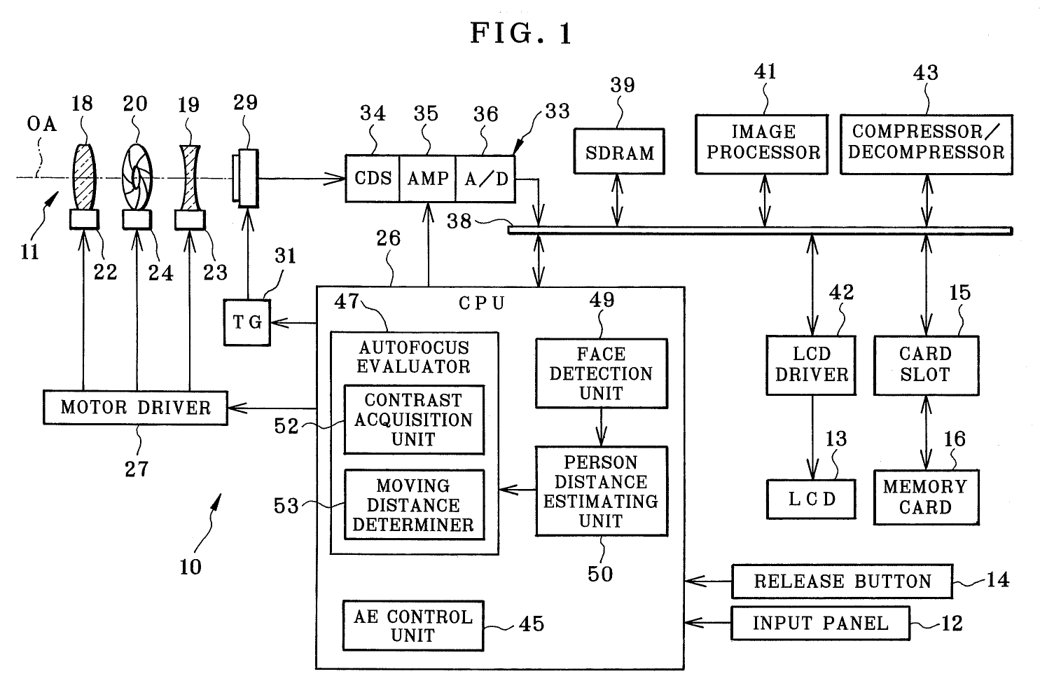

In FIG. 1, a digital still camera 10 as image pickup apparatus includes a lens system 11, an input panel 12, an LCD display panel 13, a shutter release button 14 and a memory card slot 15.

The input panel 12 includes various buttons and keys for operation of the digital still camera 10, such as a power button for turning on and off of the power source, a mode selection button for changing over the operation of the digital still camera 10, and a cursor key. Modes of the operation of the digital still camera 10 include image modes for photographing a still image, a playback mode for playing back a recorded image, and a menu mode for inputting parameters of conditions. The image modes include a normal mode and a face detecting mode. In the face detecting mode, an autofocus control (autofocus stepwise evaluation) is carried out according to data of a detected human face. In the normal mode, an autofocus control is carried out without result of face detection. Those will be described later in detail.

The LCD display panel 13 displays an image, pattern and information of various purposes. In an image mode, the LCD display panel 13 displays a live image. In a playback mode, the LCD display panel 13 displays a recorded image. In a menu mode, a menu screen pattern is displayed for setting various parameters.

The shutter release button 14 includes a two-step switch. When the shutter release button 14 is depressed halfway, AE (auto-exposure) control and autofocus control are carried out to stand by for image pickup. When the shutter release button 14 is depressed fully, an image is picked up and recorded. A memory card 16 is set in the memory card slot 15 in a removable manner. Image data obtained by the image pickup is written to the memory card 16.

The lens system 11 includes a zoom lens/lens group 18, a focus lens/lens group 19 and an aperture stop mechanism 20. A zoom motor 22 drives the zoom lens/lens group 18 to move on an optical axis OA. A focus motor 23 as lens moving mechanism drives the focus lens/lens group 19 to move on the optical axis OA. An iris motor 24 drives the aperture stop mechanism 20 to adjust the aperture value by changing an aperture diameter. Each of the motors 22-24 is a stepping motor. A motor driver 27 is connected with the stepping motor. A CPU 26 or focusing control unit causes the motor driver 27 to control the stepping motor with drive pulses.

An image pickup unit 29 or CCD image sensor is disposed behind the lens system 11. It is possible to use a MOS type of image sensor instead of the image sensor 29. The image sensor 29 includes a reception surface in which plural photoelectric conversion elements are arranged, and outputs an image signal obtained by photoelectric conversion of object light incident on the reception surface. A timing generator (TG) 31 is connected with the image sensor 29, and controlled by the CPU 26. In the image sensor 29, a shutter speed of an electronic shutter (charge storing time for each photoelectric conversion element) is determined according to a timing signal (clock pulse) input by the timing generator 31.

An analog signal processor 33 is supplied with the image signal generated by the image sensor 29. The analog signal processor 33 includes a correlated double sampling (CDS) circuit 34, an amplifier 35 as sensitivity adjuster, and an A/D converter 36. The CDS circuit 34 generates image data of R, G and B corresponding exactly to the stored charge of the respective pixels according to the image signal. The amplifier 35 amplifies the generated image data. The A/D converter 36 converts the amplified image data into a digital form.

The amplifier 35 operates as sensitivity adjuster. The ISO sensitivity of imaging with the image sensor 29 is determined according to an input gain of the amplifier 35. A data bus 38 is connected with the A/D converter 36. Image data of a digital form from the A/D converter 36 is sent through the data bus 38, and written to an SDRAM 39 in a temporary manner.

An image processor 41 reads image data from the SDRAM 39, processes the image data in gradation conversion, white balance correction, gamma correction, Y/C separation and other image processing, and then writes the processed image data to the SDRAM 39. An LCD driver 42 converts image data processed by the image processor 41 as a live image into a composite signal of an analog form, and causes the LCD display panel 13 to display the live image. Also, regarding an image to be recorded upon full depression of the shutter release button 14, a compressor/decompressor 43 compresses the image data in a JPEG format or other suitable format, so that the image data is written to the memory card 16 by use of the memory card slot 15.

Various elements in the digital still camera 10 are connected with the CPU 26, which controls the entirety of the digital still camera 10. The CPU 26 drives the elements according to control programs, control data and the like stored in a ROM (not shown).

The CPU 26 has an AE control unit 45, an autofocus evaluator 47 or AF evaluator, a face detection unit 49 as principal object detection unit, and a person distance estimating unit 50 in relation to the AE and AF controls. The AE control unit 45 is combined with the iris motor 24 to constitute an aperture stop adjuster. The AE control unit 45 analyzes image data read from the SDRAM 39 upon the half depression of the shutter release button 14. The AE control unit 45 controls the aperture value of the aperture stop mechanism 20 and the shutter speed of the electronic shutter of the image sensor 29 according to the brightness information or the like. According to the determined parameters, the AE control unit 45 causes the iris motor 24 and the timing generator 31 to adjust the aperture value and the shutter speed.

The autofocus evaluator 47 carries out the autofocus control of the contrast method upon half depression of the shutter release button 14. The autofocus control in the autofocus evaluator 47 is differently carried out between the normal mode and the face detecting mode as selected from the image modes of the digital still camera 10.

If a normal mode is set, a contrast acquisition unit 52 and the image sensor 29 are driven by the autofocus evaluator 47 while the focus motor 23 is driven to move the focus lens 19 from an MOD position toward an INF position, the MOD position being a position of the focus lens 19 for the closest focus at the nearest distance (Minimum Object Distance), the INF position being a position of the focus lens 19 for the infinity focus. The contrast acquisition unit 52 successively calculates a contrast value according to luminance value of image data stored in the SDRAM 39 and the like.

The autofocus evaluator 47 carries out the autofocus stepwise evaluation (autofocus search) of a hill climbing method known in the art. The autofocus evaluator 47 compares the contrast value acquired stepwise by a predetermined moving amount of the lens/lens group with the previous contrast value, and continues moving the lens/lens group and calculating the contrast value until the contrast value turns from the increase to the decrease. When the contrast value turns to the decrease, the autofocus evaluator 47 determines a peak position of the contrast value as an in-focus lens position, and controls the focus motor 23 to set the focus lens 19 in the in-focus lens position.

The autofocus control (autofocus stepwise evaluation) at the time of selecting the face detecting mode as image mode is described. The autofocus evaluator 47 carries out the autofocus stepwise evaluation at a higher speed than a normal mode according to a detection result of a human face with the face detection unit 49.

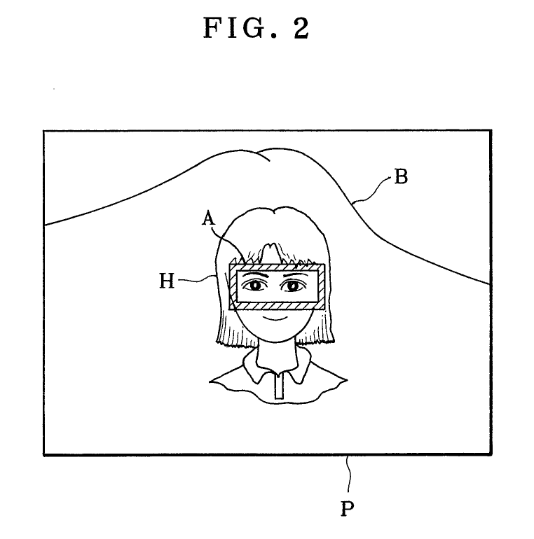

The face detection unit 49 is a principal object detection unit in the invention. When the face detecting mode is set, the face detection unit 49 detects a face of the person H within the object image P as principal object according to image data stored in the SDRAM 39, and calculates a size of the facial region in the object image P in FIG. 2.

In FIG. 2, a region A as location of eyes of a person H is determined, so that existence or lack of a person is detected by detecting the eyes. As the region with the eyes is specified, a contour of a face is determined according to colors of skin, hair and the like of the person H and relationship of positions of such body parts. A size of the face is determined according to an area of the region of the flesh color of the face. Also, it is possible to measure an interval between eyes for the purpose of determining a size of the face according to the interval. Various known methods may be used for the purpose of detecting a face, and determining a size of a facial region. A reference sign B in the drawing designates a background in a scene.

If the face of the person H is out of focus during attempt of the face detection, failure is likely to occur in the face detection. In view of this, the aperture value of the aperture stop mechanism 20 is set greater to enlarge the depth of field so that the face of the person falls within the depth of field.

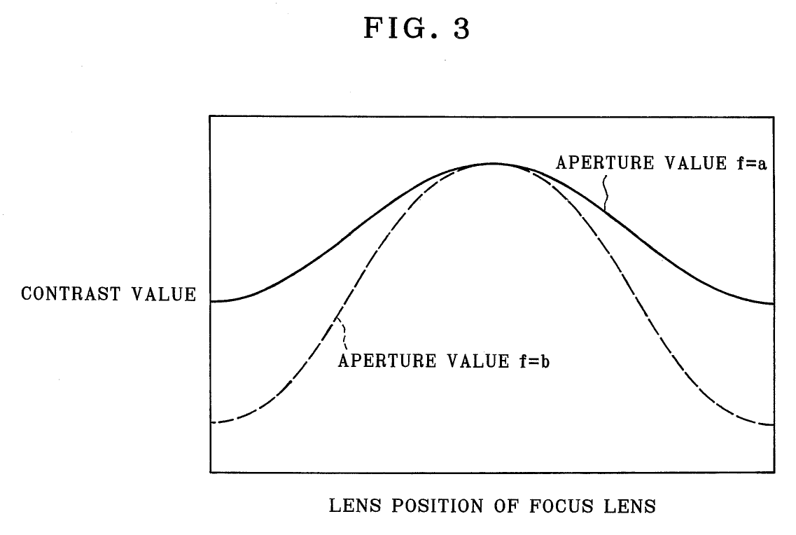

FIG. 3 illustrates curves for a relationship between the lens position of the focus lens 19 and the contrast value for the aperture values of f=a and f=b (where a>b). When the aperture value of the aperture stop mechanism 20 is small as indicated by the broken line (b), the depth of field for an in-focus state is small because of a great change in the contrast value according to movement of the focus lens 19. When the aperture value of the aperture stop mechanism 20 is great as indicated by the solid line (a), the depth of field for an in-focus state is great because of a small change in the contrast value. Therefore, possibility of a face image of the person H within the depth of field can be higher.

In the embodiment, the aperture value of the aperture stop mechanism is stepped up by one step or by plural steps, in the sequence of 1, 1.4, 2, 2.8, 4, 5.6, 8 and so on. If failure occurs in the face detection, the aperture value is increased stepwise until the face detection is successful with the face of the person H falling within the depth of field.

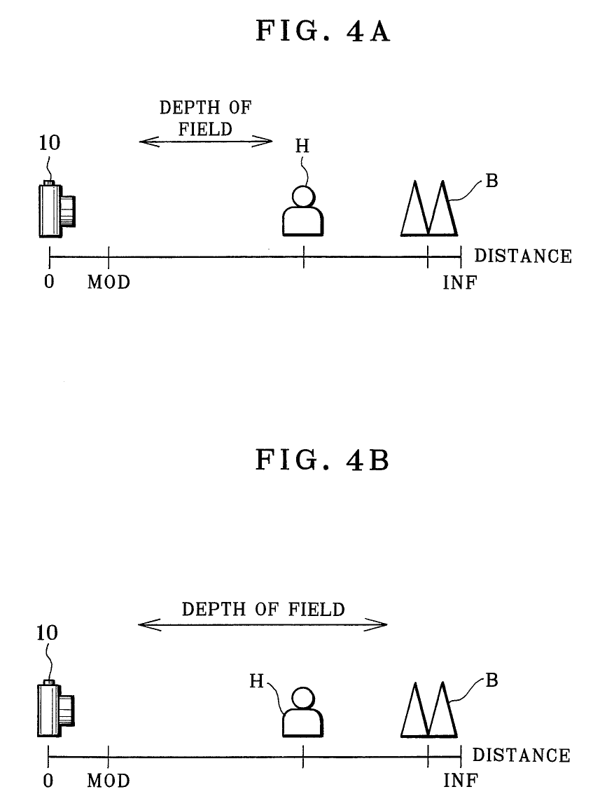

In FIG. 4A, a state of a person H not within the depth of field is illustrated. Failure occurs in the face detection as a face of the person H is out of focus. In case of failure in the face detection in the face detection unit 49, the AE control unit 45 of FIG. 1 controls the iris motor 24 to step up the aperture value of the aperture stop mechanism 20 by one step, for example, from 1.4 to 2. Then the face detection unit 49 operates for face detection again. This sequence is repeated until a person H is caused to fall within a depth of field without defocus as illustrated in FIG. 4B, to carry out the face detection successfully.

It may be conceivable to preset the aperture value with a great value instead of increasing the aperture value of the aperture stop mechanism 20 in a stepwise manner. However, an incident of small-aperture blur may occur due to diffraction with the aperture stop mechanism 20 typically when the aperture value is great, namely if the aperture stop mechanism 20 is stopped down considerably. Thus, it is preferable not to stop down the aperture stop mechanism 20 in an excessive manner.

When the aperture stop mechanism 20 is stopped down, namely when the aperture value of the aperture stop mechanism 20 is set higher, then object light incident upon the image pickup unit 29 or CCD image sensor decreases. In FIG. 1, the A/D converter 36 raises an input gain of the amplifier 35 according to the increase in the aperture value of the aperture stop mechanism 20, to set higher the ISO sensitivity of imaging with the image sensor 29. Thus, brightness of an image is corrected by compensating for the drop in the brightness due to the decrease in the object light.

The person distance estimating unit 50 operates for estimating the distance. The person distance estimating unit 50 receives the focal length information of the lens system 11 generated by the autofocus evaluator 47 and facial region size information determined by the face detection unit 49, and determines an estimated distance Ls to the face of the person H. In the embodiment, a lens moving distance to move the focus lens 19 from the IMF position to the MOD position according to the estimated distance Ls. The autofocus stepwise evaluation is carried out while the focus lens 19 is moved from the INF position by the lens moving distance. Moving of the focus lens 19 from the IMF position to the MOD position will be hereinafter described with an example of the lens system 11 having a 35 mm equivalent focal length of 300 mm.

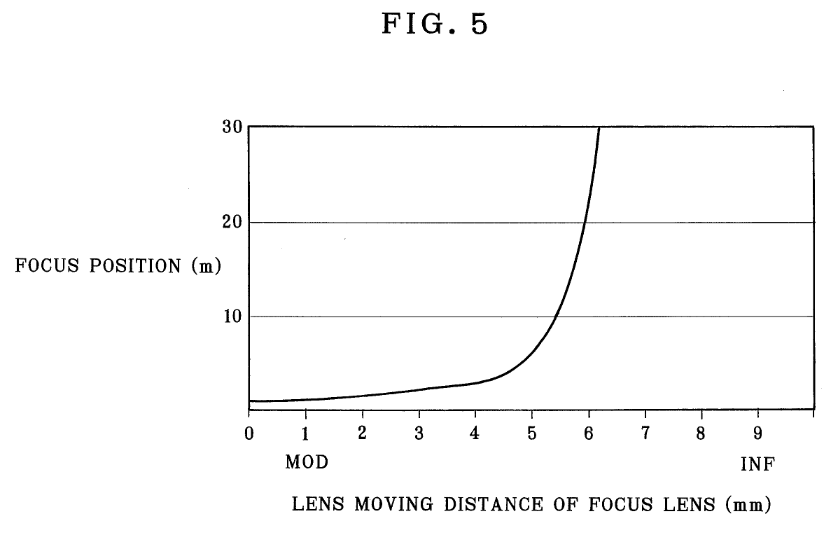

In FIG. 5, the depth of field is small on the MOD side. It is necessary to set small the variation amount (meters) of the focus distance (position) relative to a lens moving distance (mm) of the focus lens 19. In contrast, the depth of field is great on the INF side. It is possible to set great the variation amount (meters) of the focus distance (position) relative to a lens moving distance (mm) of the focus lens 19. A range of the autofocus stepwise evaluation (lens moving distance) can be set small by starting from the INF side where the variation amount of the focus distance is great.

In Table 1, data obtained in the condition of orienting the camera horizontally and by targeting the person H from his or her waist to the head are indicated. The data include relationships between the focal length (mm) in 35 mm equivalence of the lens system 11, the object distance to the person (meters), namely to the person's face, the lens moving distance from the MOD position to the person H in the autofocus stepwise evaluation, and the lens moving distance from the INF position to the person H in the autofocus stepwise evaluation. In relation to data in Table 1, a vertical size from the waist to the head of the person H is 0.85 meter.

TABLE 1

| Focal | | | | | |
|---|---|---|---|---|---|
| length | Object | Lens moving | | Ratio between lens | |
| (mm) | distance | distance | | moving distances | |
| in 35 mm | to | From MOD | From INF | From MOD | From INF |
| equiv- | person | to person | to person | to person | to person |
| alence | (m) | (mm) | (mm) | (%) | (%) |
| 28 | 0.99 | 0.08 | 0.08 | 50 | 50 |
| 35 | 1.24 | 0.17 | 0.12 | 59 | 41 |
| 50 | 1.77 | 0.46 | 0.20 | 70 | 30 |
| 100 | 3.54 | 1.33 | 0.27 | 83 | 17 |
| 200 | 7.08 | 4.75 | 0.63 | 88 | 12 |
| 300 | 10.63 | 5.84 | 1.02 | 85 | 15 |

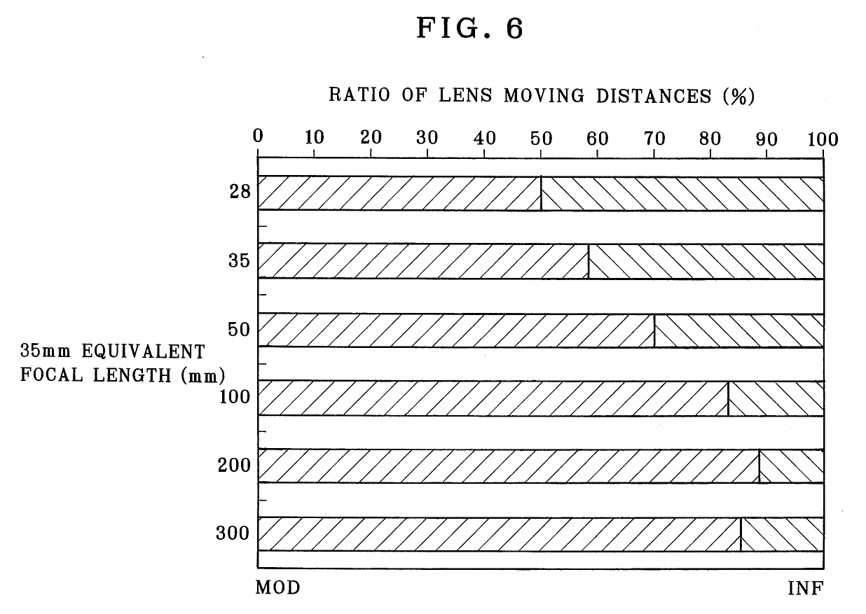

In Table 1, ratios between the lens moving distances from the MOD position to the person and from the INF position to the person are indicated, the ratios being defined to 100% as a lens moving path required for focusing between the INF side and the MOD side. Also, the ratio of the lens moving distances is indicated in the graph of FIG. 6 for each of 35 mm equivalent focal lengths. In FIG. 6, the left regions indicate the ratio of the lens moving distance from the MOD position to the person. The right regions indicate the ratio of the lens moving distance from the INF side to the person.

As is observed from Table 1 and FIG. 6, it is possible to shorten the time and distance required for the autofocus stepwise evaluation in the direction from the INF side to the MOD side in comparison with the direction from the MOD side to the INF side, regarding the normally expectable distance of a person (except for 28 mm of 35 mm equivalent focal length and 28 mm of a distance of a person). If 35 mm equivalent focal length is 300 mm, the evaluation time can be approximately 20% as long as that according to the conventional method.

Also, the focus lens 19 is moved from the IMF position to the MOD position in the autofocus stepwise evaluation, so that the evaluation time can be shortened to quicken the autofocus control. A focus position of the background B can be detected before a focus position (focus distance) of the face of the person H is detected. As a result, the autofocus control satisfying the intention of the photographer is possible because both of the person and background can be focused.

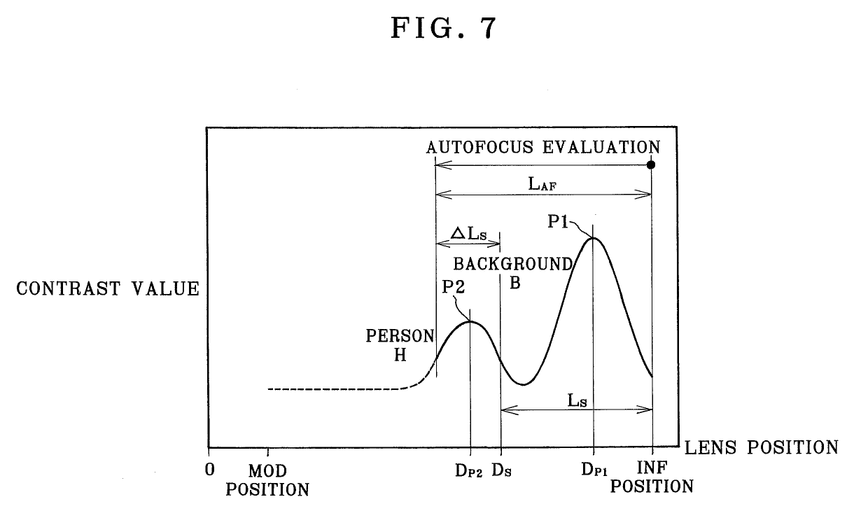

The face detection unit 49 detects a face in FIG. 1. An estimated distance Ls to the face of the person H is obtained by the person distance estimating unit 50. A moving distance determiner 53 in the autofocus evaluator 47 is supplied with data of the estimated distance. The moving distance determiner 53 as a corrector operates according to a result of correction of a distance error ΔLs (See FIG. 7) for the estimated distance Ls with the person distance estimating unit 50, and determines a lens moving distance LAF (a range of autofocus stepwise evaluation) for moving the focus lens 19 from the IMF side toward the MOD side.

The reason of the correction with the distance error ΔLs for the estimated distance Ls is that the estimated distance Ls determined by the person distance estimating unit 50 is different from an exact value of the distance. Typically if the estimated distance Ls is found shorter than the exact value as tendency of the face recognition, it is necessary to set a completion position of the autofocus stepwise evaluation on the MOD side in comparison with the estimated in-focus position DS of the focus lens 19 (See FIG. 7) of estimated focusing on the face of the person H. In general, there are specific differences between individual faces, in particular young and old faces. A lens moving distance should be determined with safety in view of the specific differences. Note that the value of the distance error ΔLs may be constant for each of types of digital still cameras, and also may be changeable according to the estimated distance Ls being determined.

When the moving distance determiner 53 determines the lens moving distance LAF, the autofocus evaluator 47 drives the focus motor 23. The image pickup unit 29 or CCD image sensor and the contrast acquisition unit 52 are driven while the focus lens 19 is moved from the INF position toward the MOD position by an amount of the lens moving distance LAF. The contrast acquisition unit 52 carries out the autofocus stepwise evaluation of successively acquiring a contrast value by a predetermined moving amount of the focus lens 19.

In FIG. 7, a contrast curve is illustrated to express a relationship between a lens position of the focus lens 19 obtained by the autofocus stepwise evaluation and the contrast value. A peak position P1 corresponding to the background B and a peak position P2 corresponding to the person H are located on the contrast curve. As is described above, the lens moving distance LAF is a distance obtained by adding the distance error ΔLs to the estimated distance Ls. The completion position of the autofocus stepwise evaluation is on the MOD side in comparison with the estimated in-focus lens position DS and the peak position P2. The sign DP1 designates a lens position of the focus lens 19 corresponding to the peak position P1. The sign DP2 designates a lens position corresponding to the peak position P2.

According to the contrast curve obtained by the autofocus stepwise evaluation, the autofocus evaluator 47 determines the lens position DP2 as an in-focus lens position for the face of the person H in correspondence with a peak position P2 which is the closest focus on the MOD side. Then the autofocus evaluator 47 controls the focus motor 23 to set the focus lens 19 in the determined in-focus lens position. Then the autofocus control in the face detecting mode is completed.

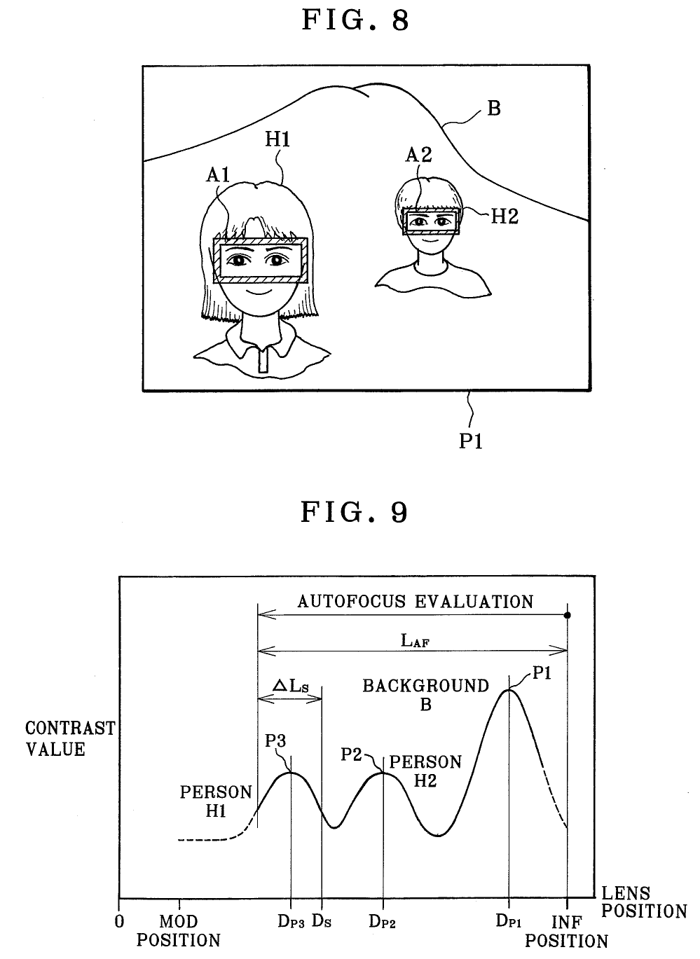

In the above description, only one person is present in the object image P of FIG. 2. However, plural persons can be present in an object image P1 as illustrated in FIG. 8. The face detection unit 49 detects a region A1 with eyes of a person H1 and a region A2 with eyes of a person H2, to detect faces of the persons H1 and H2. Also, sizes of the facial regions are obtained.

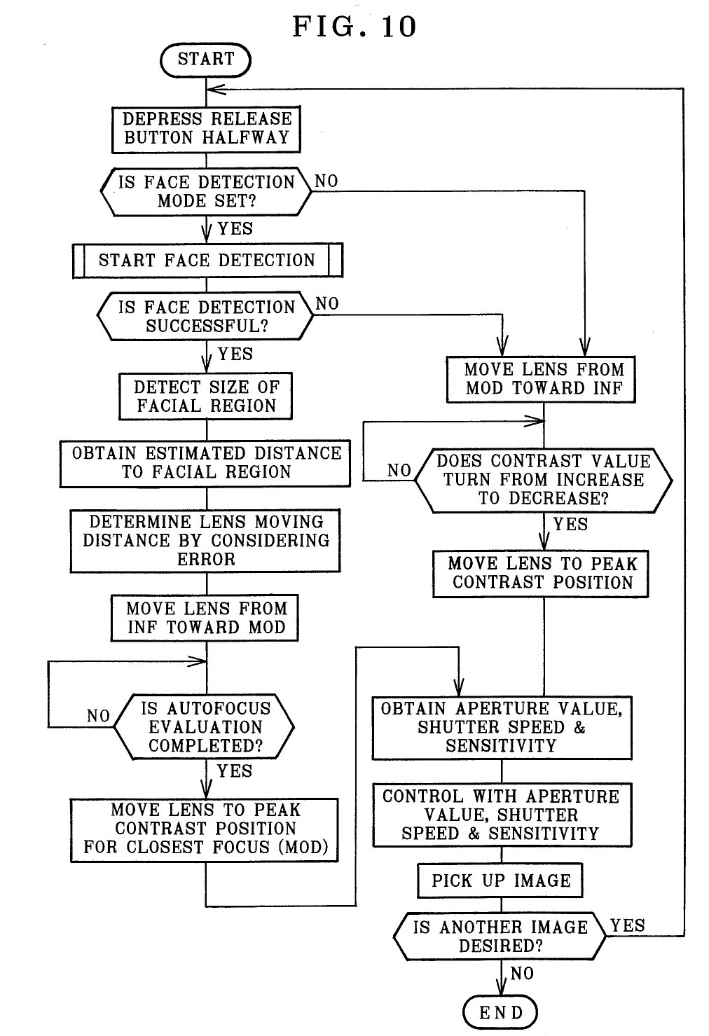

Among the plural persons, the person distance estimating unit 50 selects a face of the person H1 with a greater size of a facial region, namely at the closer focus. The estimated distance Ls is calculated according to the size of the facial region of the selected person H1. In a similar manner, the determination of the lens moving distance LAF and the autofocus stepwise evaluation are carried out. In FIG. 9, peak positions P1, P2 and P3 lie on the contrast curve obtained by the autofocus stepwise evaluation, the peak position P1 corresponding to the background B, the peak position P2 corresponding to the farther person H2, the peak position P3 corresponding to the nearer person H1.

The autofocus evaluator 47 determines the lens position DP3 corresponding to the peak position P3 as in-focus lens position, on the basis of the peak position of the closest focus on the MOD side according to the contrast curve. The autofocus evaluator 47 moves and sets the focus lens 19 in the in-focus lens position. Similarly, if three or more persons are present in an object image, operation follows according to a size of the facial region having a largest size among facial regions. Then the estimated distance Ls and lens moving distance LAF are determined. The autofocus stepwise evaluation is carried out. Also, the focus lens 19 is moved.

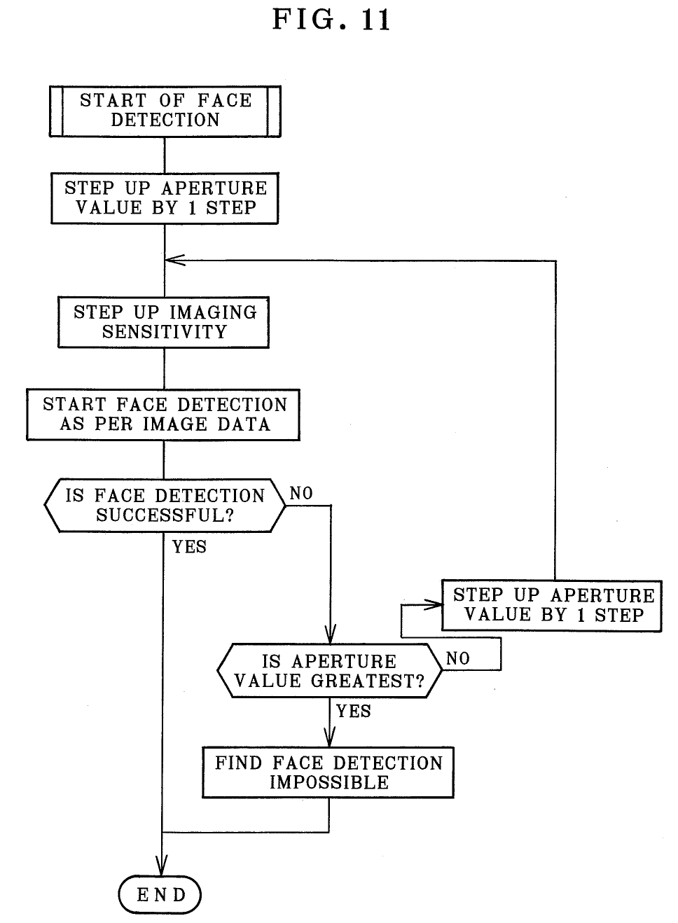

In FIGS. 10 and 11, the autofocus control of the digital still camera 10 is illustrated. The power source for the digital still camera 10 is turned on. An image mode is set, so that a live image is displayed on the LCD display panel 13. The CPU 26 checks whether the shutter release button 14 is depressed halfway or not. If not, then the digital still camera 10 stands by until half depression of the shutter release button 14.

If the shutter release button is found depressed halfway, the CPU 26 checks which of the normal mode and the face detecting mode is set as an image mode. If the normal mode is found set, then the autofocus evaluator 47 carries out the autofocus stepwise evaluation (autofocus search) of the hill climbing method without using results of the face detection.

The autofocus evaluator 47 drives the focus motor 23 to move the focus lens 19 from the MOD position toward the INF position, and drives the image pickup unit 29 or CCD image sensor and the contrast acquisition unit 52. The contrast acquisition unit 52 successively acquires a contrast value by a predetermined unit amount of moving the lens. When the contrast value inverts from an increase to a decrease, the autofocus evaluator 47 determines an in-focus lens position from the peak contrast. Then the autofocus evaluator 47 controls the focus motor 23 to set the focus lens 19 in the in-focus lens position.

If the face detecting mode is set as image mode, then the face detection unit 49 starts the face detection. See FIG. 11. The AE control unit 45 controls the iris motor 24, and steps up the aperture value of the aperture stop mechanism 20 to enlarge the depth of field. Thus, possibility of falling a face of the person H within the depth of field becomes higher. At the same time, the CPU 26 raises the input gain of the amplifier 35 according to the increase of the aperture value and raises the ISO sensitivity of imaging with the image sensor 29 so as to compensate for a drop in the brightness of the image according to decrease in the amount of the object light incident upon the image sensor 29.

After the aperture value and the ISO sensitivity are adjusted, the face detection unit 49 determines a size of a facial region by detecting the face of the person H in the image P according to the image data read from the SDRAM 39. If failure occurs in the face detection, the aperture value of the aperture stop mechanism 20 is set higher by one step. The ISO sensitivity of imaging with the image sensor 29 is set higher. Then face detection is carried out again. This is repeated until face detection is completed successfully. If failure still occurs in the face detection even with the greatest aperture value, then it is judged that the face detection is impossible. The autofocus stepwise evaluation of the normal mode described above is started.

When the size of the facial region in the object image is determined, the person distance estimating unit 50 calculates an estimated distance Ls to the person H according to the determined size of the facial region and the focal length information of the lens system 11. The person distance estimating unit 50 sends data of the estimated distance Ls to the moving distance determiner 53. If plural faces are detected by the face detection unit 49, the estimated distance Ls to one of the faces according to the largest size of the facial region is obtained. The moving distance determiner 53 as a corrector determines the lens moving distance LAF according to a result of correcting the estimated distance Ls with the distance error ΔLs.

Then the autofocus evaluator 47 drives the focus motor 23 to move the focus lens 19 from the INF side toward the MOD side by the lens moving distance LAF, and drives the image sensor 29 and the contrast acquisition unit 52. The autofocus stepwise evaluation is carried out to calculate the contrast value successively by a predetermined amount of moving the lens until the focus lens 19 becomes moved by the lens moving distance LAF.

When the autofocus stepwise evaluation is completed, the autofocus evaluator 47 determines a lens position as an in-focus lens position in correspondence with a peak contrast of the closest focus on the MOD side, according to the contrast curve. See FIG. 7. The autofocus evaluator 47 controls the focus motor 23 to move and set the focus lens 19 in the in-focus lens position. Thus, the autofocus control is terminated.

The image data recorded in the SDRAM 39 is analyzed. Various parameters are determined according to brightness information of an object from the image data, so as to optimize the photographing condition, the parameters including the aperture value of the aperture stop mechanism 20, the electronic shutter speed of the image sensor 29, ISO sensitivity of imaging with the image sensor 29 and the like by means of the AE control unit 45, the CPU 26 and the like. According to the determined parameters, the aperture stop, the electronic shutter speed, and ISO sensitivity are controlled. The preparation for image pickup is completed.

After this, the CPU 26 checks whether the shutter release button 14 is depressed fully. If it is not, then the CPU 26 continues standing by for the full depression. If the shutter release button 14 is found depressed fully, then the CPU 26 causes the image sensor 29 to pick up an image.

An image signal output by the image sensor 29 is converted by the analog signal processor 33 into digital image data, which is processed by the image processor 41 and compressed by the compressor/decompressor 43. The image data is written to the memory card 16 by means of the memory card slot 15. If a user wishes to take another exposure, the above-described autofocus control and photographing sequence can be repeated.

Consequently, it is possible according to the embodiment to obtain high possibility of causing a human face to fall within the depth of field, because the aperture value is enlarged to set the depth of field great. The face detection can be successful with a higher probability. The time required for changing the aperture value according to the invention is shorter than that disclosed in U.S. Pat. Pub. No. 2007/030381 (corresponding to JP-A 2006-201282) for moving the focus lens to a position of a hyperfocal distance. The time for the face detection can be shorter.

In the present embodiment, the ISO sensitivity of imaging with the image sensor 29 is set higher when the aperture value is set great. Thus, it is possible to correct a decrease in the brightness in the image due to the decrease in the light amount of object light incident upon the image sensor 29.

The autofocus stepwise evaluation is carried out by moving the focus lens 19 to the MOD position from the INF position with a great variation amount of a focus position, by the lens moving distance LAF determined according to the face detection. Thus, the time for auto focus stepwise evaluation can be shortened. Also, a focus position for the background can be detected by starting the autofocus stepwise evaluation from the INF position. The autofocus control can be based on the intention of a user, as both of the person and the background can be focused.

It is possible to set the focus lens 19 in-focus on a nearest one of the persons on the MOD side for the closest focus, because an estimated distance Ls is calculated according to the largest size of a facial region upon detection of plural persons in the face detection.

In the embodiment, the autofocus stepwise evaluation in the face detecting mode is carried out while the focus lens 19 is moved from the INF position toward the MOD position. However, the invention is not limited to this construction. For example, the autofocus stepwise evaluation in the face detecting mode may be carried out while the focus lens 19 is moved from the MOD position toward the INF position. This is effective in reducing the lens moving distance to shorten the evaluation time typically when the person H is located at a near distance with which the close focus is used.

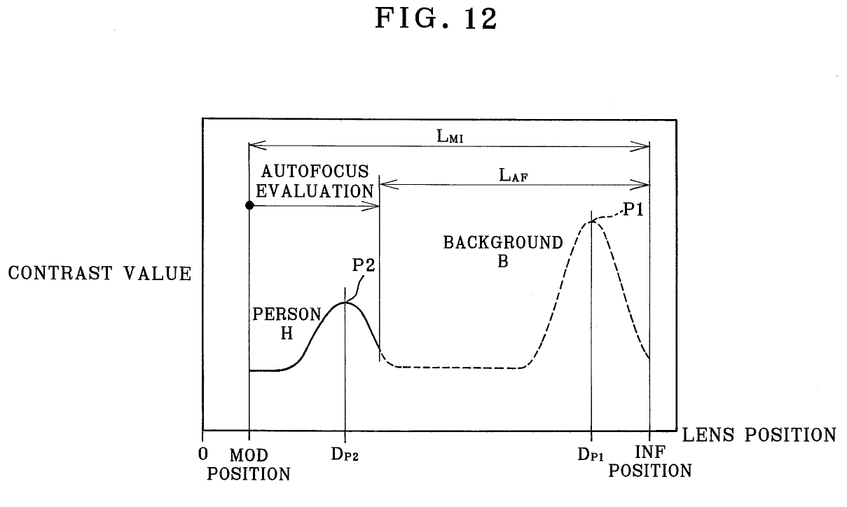

For this event, the autofocus evaluator 47 may operate for the autofocus stepwise evaluation by moving the focus lens 19 from the MOD side toward the INF side if the lens moving distance LAF from the moving distance determiner 53 is more than a half of the distance LMI between the MOD position and the INF position. See FIG. 12.

Another preferred embodiment of autofocus control in the face detection is described now. The focus lens 19 is moved to the in-focus lens position before the aperture stop mechanism 20 is adjusted to focus the background B as well as the person H.

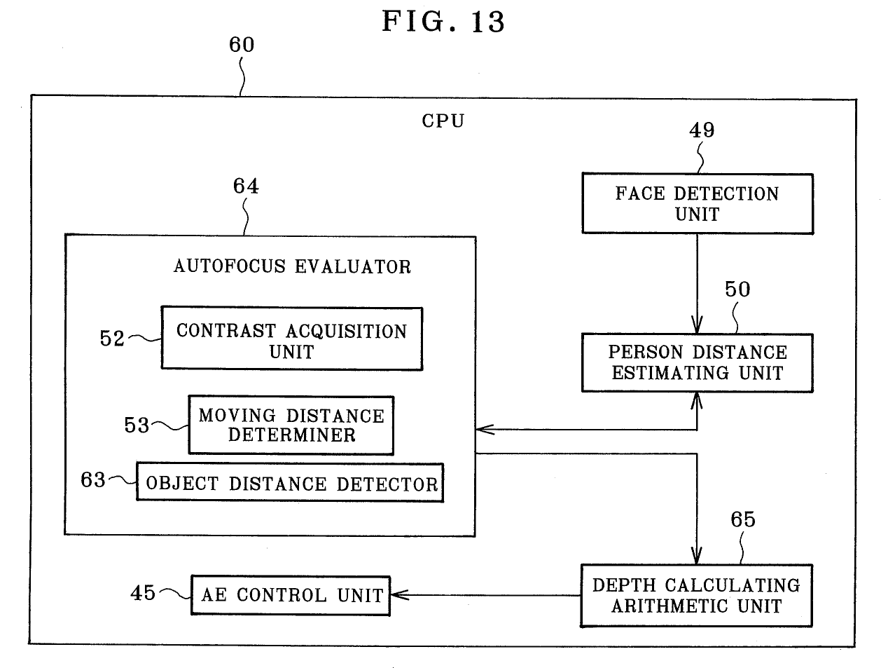

In FIG. 13, a digital still camera of the embodiment includes a CPU 60 or focusing control unit in place of the CPU 26. Elements similar to those of the above embodiment are designated with identical reference numerals. The CPU 60 has components included in the CPU 26. In addition, the CPU 60 includes an autofocus evaluator 64 or AF evaluator, and a depth calculating arithmetic unit or aperture value acquisition unit 65. The autofocus evaluator 64 has an object distance detector 63.

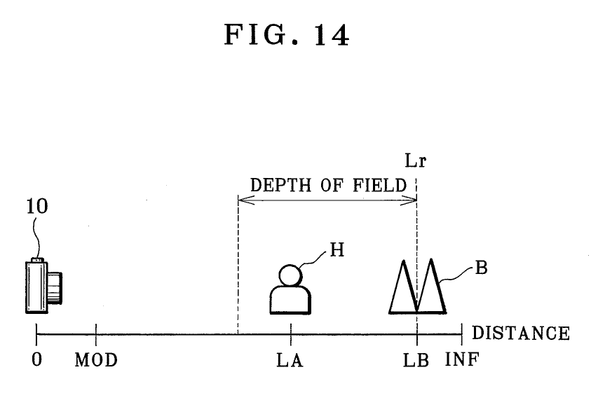

The object distance detector 63 operates according to the contrast value (contrast curve) acquired by the autofocus stepwise evaluation and the position of the focus lens at the time of acquiring the contrast value, and determines a principal object distance LA to the person H and an auxiliary object distance LB to the background B. See FIG. 14. For the determination, lens positions DP1 and DP2 and an equation or data table are used, the lens positions DP1 and DP2 corresponding to peak positions P1 and P2 of the contrast curve, the equation or data table being stored in the CPU 60. If plural persons are present, the object distance detector 63 obtains the principal object distance LA to one of the persons at the nearest distance on the MOD side. Data of the object distances LA and LB are sent to the arithmetic unit 65.

In FIG. 14, calculation of the depth of field in the arithmetic unit 65 is illustrated. When the focus lens 19 is set in the in-focus lens position for focusing on a person H with the principal object distance LA, the arithmetic unit 65 acquires an aperture value of the aperture stop mechanism 20 to cause a background B (at a distance LB) to fall within the depth of field of the lens system 11 (rear depth of field Lr) in accordance with obtained values of the principal and auxiliary object distances LA and LB. To determine the depth of field, Equation 1 known in the art for the rear depth of field Lr is used.

Lr=σfL²/(F²−σfL) Equation 1

In Equation 1, σ is a diameter of a permissible circle of confusion for expressing a permissible blur amount in focusing on the image sensor 29;

f is an aperture value of the aperture stop mechanism 20;

L is an object distance LA to a person H;

F is a focal length of the lens system 11.

Among those values, σ and F are previously determined before the image pickup. Data of σ is stored in a ROM (not shown) or the like in the arithmetic unit 65. Data of F is sent by the autofocus evaluator 64 to the arithmetic unit 65. The arithmetic unit 65 for depth calculation calculates the aperture value f according to Equation 2 defined by substitution of the principal and auxiliary object distances LA and LB for the terms of L and Lr in Equation 1.

LB=σf(LA)²/[(F²−σf(LA)] Equation 2

It is possible according to Equation 2 to determine an aperture value to cause the background B of the auxiliary object distance LB to fall within the depth of field (rear depth of field Lr) while the focus lens 19 is in the in-focus lens position. Note that it is possible to carry out correction to set the background B safely in the depth of field inward from the boundary of the depth of field, in a manner different from that of FIG. 14 in which the background B is set in the depth of field exactly on the boundary of the depth of field. The aperture value is input to the AE control unit 45.

The AE control unit 45 controls the iris motor 24 according to the determined aperture value, and adjusts the aperture stop of the aperture stop mechanism 20. When the aperture value of the aperture stop mechanism 20 is higher, the amount of object light incident upon the image sensor 29 is lower. In view of this, the CPU 60 raises an input gain of the amplifier 35 according to the greater aperture value of the aperture stop mechanism 20, to raise the ISO sensitivity of imaging with the image sensor 29.

If the object brightness is lower than a predetermined level, shortage occurs in an amount of received light on the image sensor 29 in the case of the aperture value obtained by Equation 2 above. Thus, it is preferable to determine the aperture value by considering balancing between the shutter speed of the electronic shutter and the ISO sensitivity.

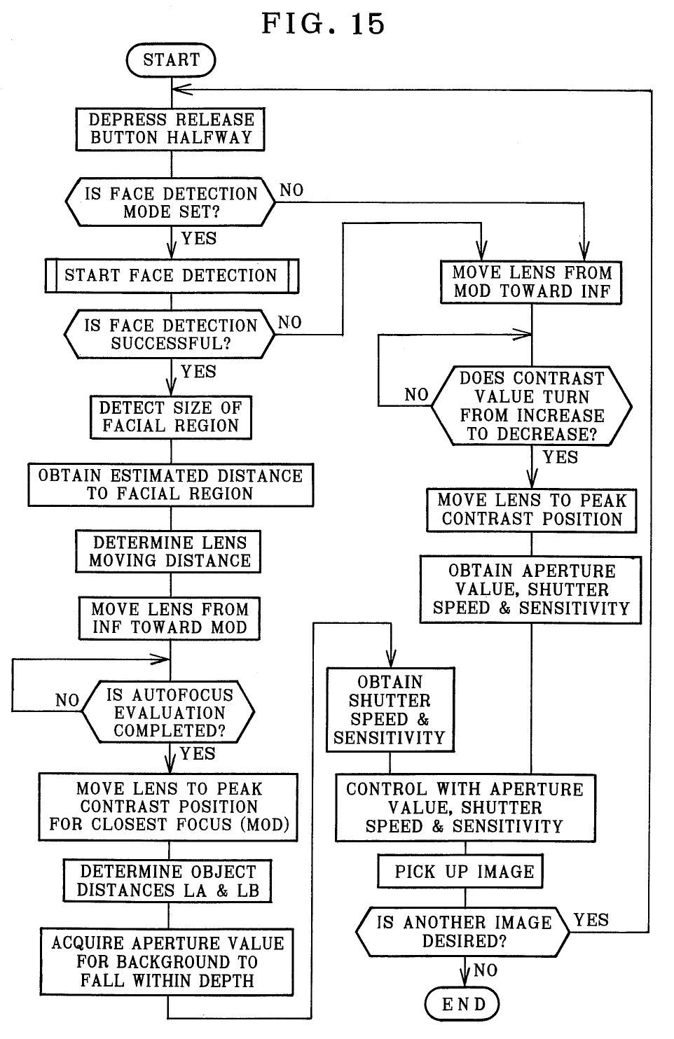

The autofocus control of the embodiment is described now with FIG. 15. An initial sequence according to the first embodiment is repeated, including steps after the normal mode is selected as image mode and until the autofocus stepwise evaluation is completed in the face detecting mode.

After the focus lens 19 is set in the in-focus lens position in the face detecting mode, the object distance detector 63 of the autofocus evaluator 64 determines the principal and auxiliary object distances LA and LB according to the contrast curve obtained by autofocus stepwise evaluation and the positions of the focus lens in acquiring the contrast values. The object distance detector 63 sends information of the object distances to the arithmetic unit 65.

The arithmetic unit 65 for the depth calculation substitutes plural values for terms in Equation 2, the plural values including the diameter σ of a permissible circle of confusion and the focal length F stored previously, and the principal and auxiliary object distances LA and LB. The aperture value of the aperture stop mechanism 20 to set the background B to fall within the depth of field of the lens system 11 is determined according to depth of field calculation. Data of the aperture value as a result is sent to the AE control unit 45.

If the aperture value is set higher, the CPU 60 determines ISO sensitivity of imaging with the image sensor 29 to optimize the condition of photographing. The ISO sensitivity of imaging is set higher if the aperture value becomes higher. This is effective in compensating for a drop in the brightness due to a decrease in the light amount of light incident on the image sensor 29. At the same time, the AE control unit 45 determines a shutter speed of the electronic shutter of the image sensor 29 to optimize the condition of photographing.

In a manner similar to the first embodiment, the aperture value, electronic shutter speed, ISO sensitivity and the like are controlled and set, before steps to prepare for image pickup are completed. These are the same as those of the first embodiment.

In the embodiment, the aperture value for causing the background B to fall within the depth of field is acquired by determining the principal and auxiliary object distances LA and LB. It is possible to focus the background B even in photographing the person H. The autofocus stepwise evaluation is the same as the first embodiment, so similar effect of the first embodiment can be obtained regarding reduced time and the like.

Still another preferred autofocus control in the face detection is described now. The result of the autofocus stepwise evaluation according to the first embodiment is utilized. An in-focus lens position of the focus lens 19 is determined to cause the background B to fall within the depth of field as well as possible. Specifically, the focus distance is corrected in the direction toward the background to cause the background B to fall within the depth of field.

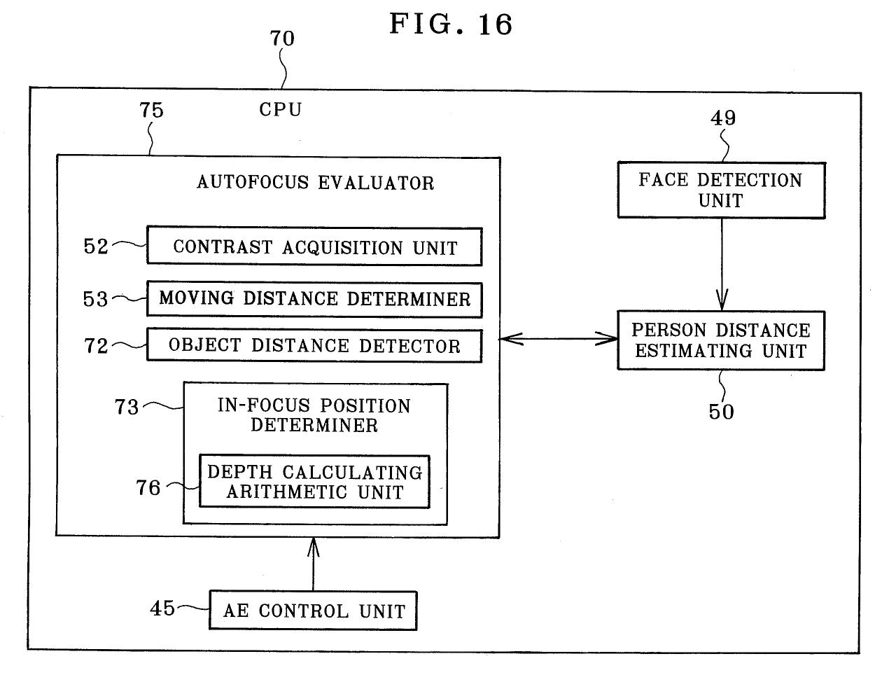

In FIG. 16, a CPU 70 as focusing control unit is incorporated in the digital still camera. The basic structure of the CPU 70 is the same as that of the CPU 26. In addition, an autofocus evaluator 75 or AF evaluator is included in the CPU 70, and has an object distance detector 72 and an in-focus position determiner 73 or corrected position determiner.

The object distance detector 72 is structurally the same as the object distance detector 63 in FIG. 13 of the second embodiment. The object distance detector 72 calculates the principal and auxiliary object distances LA and LB according to the autofocus stepwise evaluation. A depth calculating arithmetic unit or aperture value acquisition unit 76 is supplied with data of the principal and auxiliary object distances LA and LB.

The arithmetic unit 76 for the depth calculation operates according to the principal and auxiliary object distances LA and LB, and obtains a focus distance with which the background B (auxiliary object distance LB) falls within the depth of field. For the depth of field calculation, Equation 1 for the rear depth of field Lr and the following Equation 3 for the front depth of field Lf are used.

Lf=σfL²/(F²+σfL) Equation 3

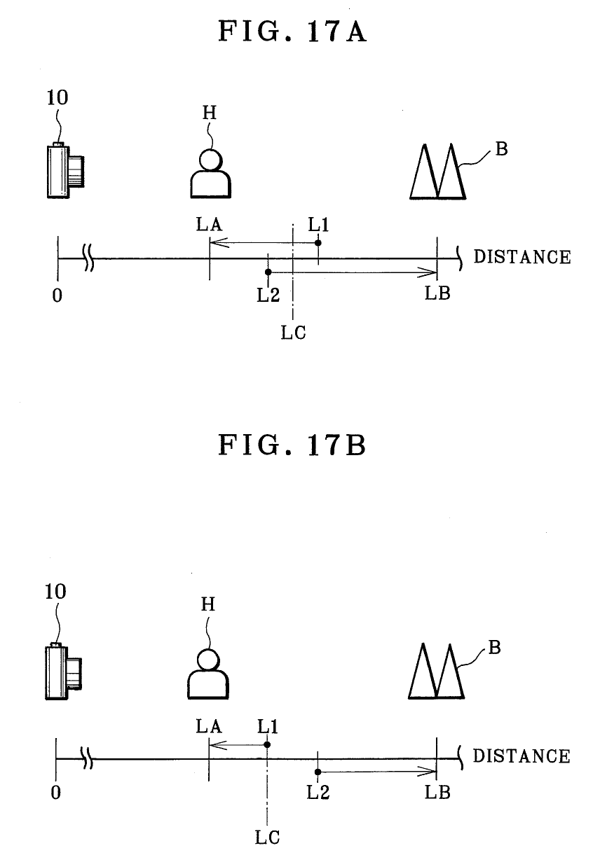

Among the terms in Equations 1 and 3, σ, F and f are previously determined before the image pickup. The arithmetic unit 76 calculates a focus distance L1 according to Equation 4 defined by substitution of the principal object distance LA for the term of Lf in Equation 3, the focus distance L1 being so determined as to cause the distance equal to or more than the principal object distance LA (person H) to fall within the depth of field. See FIGS. 17A and 17B. Note that the focus distance L1 is a distance with which the principal object distance LA (person H) falls within the front depth of field Lf when the lens system 11 is focused at the focus distance L1.

LA=σf(L1)²/[(F²+σf(L1)] Equation 4

Also, the arithmetic unit 76 calculates a focus distance L2 to cause a distance equal to or less than the auxiliary object distance LB (background B) to fall within the depth of field, by use of Equation 5 in which the auxiliary object distance LB substitutes for Lr in Equation 1. See FIGS. 17A and 17B. Note that the focus distance L2 is a distance with which the auxiliary object distance LB (background B) falls within the rear depth of field Lr when the lens system 11 is focused at the focus distance L2.

LB=σf(L2)²/[(F²−σf(L2)] Equation 5

Then the in-focus position determiner 73 compares the focus distances L1 and L2. If L1≧L2 in FIG. 17A, a point of the focus distance between the focus distances L1 and L2 is focused. Any of objects between the principal and auxiliary object distances LA and LB falls within the depth of field. Thus, the arithmetic unit 76 determines the focus distance LC as an average between the focus distances L1 and L2 according to Equation 6. Note that the arrow for the direction toward the left in FIG. 17 indicates the front depth of field. The arrow toward the right indicates the rear depth of field.

LC=(L1−L2)/2+L2 Equation 6

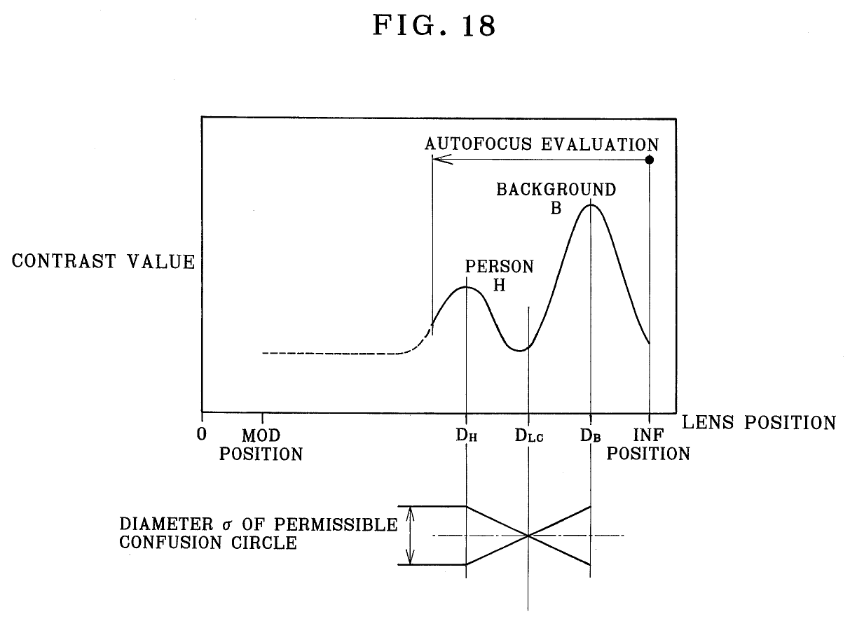

If L1=L2 as illustrated in FIG. 18, both of the person H and the background B can be focused sharply in the limit of the standard of the diameter σ of the permissible circle of confusion. In short, the both of the person H and the background B can be focused within the depth of field on the boundary of the depth of field. Note that a reference sign DLC is a lens position or in-focus lens position corresponding to the focus distance LC.

If L1<L2 as illustrated in FIG. 17B, there is no solution to cause objects between the principal and auxiliary object distances LA and LB to fall within the depth of field. Then the in-focus position determiner 73 or corrected position determiner determines the focus distance L1 as the focus distance LC according to Equation 7 to focus the person.

LC=L1 Equation 7

Note that focusing should be carried out mainly for the person H in comparison with the background B. Weighting coefficients can be additionally used in Equations 6 and 7 for weighting to the person H.

After the focus distance LC is determined, the in-focus position determiner 73 determines a lens position of the focus lens 19 as an in-focus lens position in correspondence with the focus distance LC. The autofocus evaluator 75 drives the focus motor 23 to move and set the focus lens 19 in the in-focus lens position.

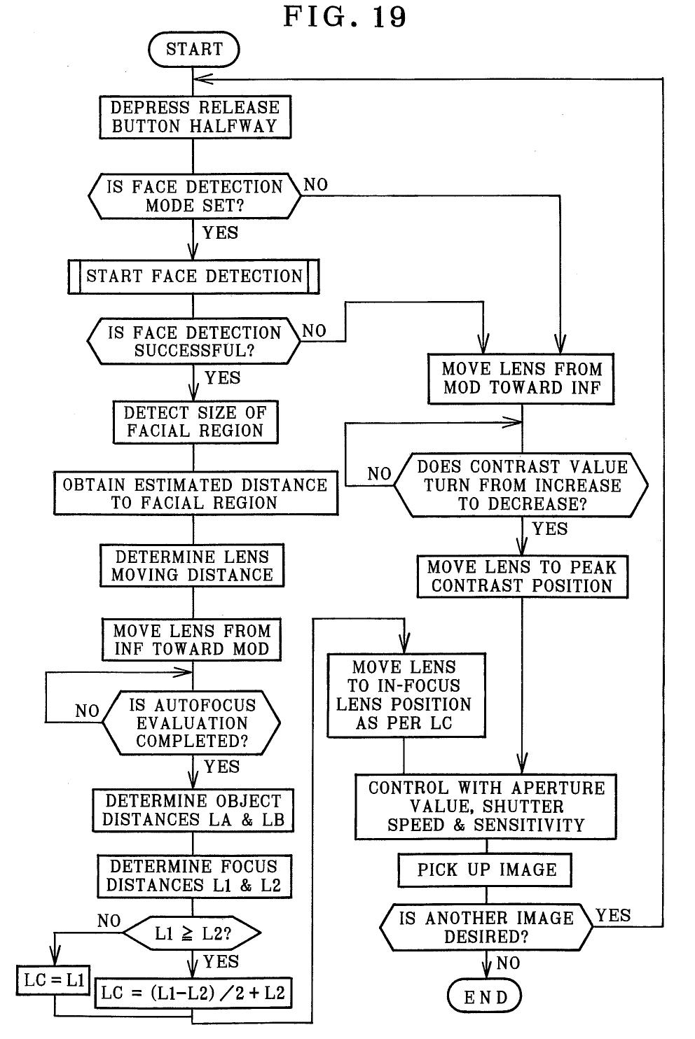

The autofocus control of the embodiment is described now with the flow chart of FIG. 19. An initial sequence according to the first embodiment is repeated, including steps after the normal mode is selected as image mode and until the autofocus stepwise evaluation is completed in the face detecting mode.

Upon the completion of the autofocus stepwise evaluation in the face detecting mode, the object distance detector 72 of the autofocus evaluator 75 determines the principal and auxiliary object distances LA and LB according to the autofocus stepwise evaluation, and sends the data of those to the arithmetic unit 76.

The arithmetic unit 76 for the depth calculation substitutes plural values for terms in Equations 4 and 5, the plural values including the diameter σ of a permissible circle of confusion and the focal length F stored in the autofocus evaluator 75, the principal and auxiliary object distances LA and LB obtained previously, and the aperture value f of the aperture stop mechanism 20 input by the AE control unit 45. Thus, the arithmetic unit 76 determines focus adjusting distances L1 and L2 by the depth of field calculation.

The in-focus position determiner 73 compares the focus distances L1 and L2. If L1≧L2, the in-focus position determiner 73 determines the focus distance LC according to Equation 6. If L1<L2, the in-focus position determiner 73 determines the focus distance LC according to Equation 7. Then the in-focus position determiner 73 determines a lens position corresponding to the focus distance LC as in-focus lens position.

The autofocus evaluator 75 drives the focus motor 23, and moves and sets the focus lens 19 in the determined in-focus lens position. In a manner similar to the first embodiment, the aperture value, electronic shutter speed, ISO sensitivity and the like are controlled and set, before steps to prepare for image pickup are completed. These are the same as those of the first embodiment.

In conclusion, the background B can be focused at the time of focusing the person H in the embodiment where the focus distance LC is used, owing to the use of the depth-priority control of exposure. Furthermore, there is an effect of shortening the evaluation time in a manner similar to the first embodiment.

In the above three embodiments, the person H and background B are photographed as principal and auxiliary objects in an object image. However, the invention is not limited to the embodiments. A principal object may be an animal, plant, building or article of a certain predetermined type. A specific object detector for any of such types of principal objects may be used in place of the face detection unit 49 described above. Also, an auxiliary object may be a person, animal, plant, building or article of a certain predetermined type in place of the background.

In the second and third embodiments, the depth-priority control of exposure is used. The background B is caused to fall within the depth of field while the face detecting mode is set as image mode. However, it is possible to add a selection switch for selectively setting a mode to cause the background B to fall within the depth of field.

In any of the above embodiments, the shutter speed of the image pickup unit 29 or CCD image sensor is adjusted by the electronic shutter in the AE control. However, a mechanical shutter may be used instead of the electronic shutter.

The camera of the above embodiments is the digital still camera. However, a camera of the invention may be a camera built-in cellular telephone, camera built-in PDA (personal digital assistant), and other instruments for image pickup.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. An image pickup apparatus comprising:
a lens system having a focus lens;
an image sensor for picking up an image formed by said lens system to generate an image signal by conversion;
a detection unit for detecting a principal object by image analysis according to said image signal;
a distance estimating unit for determining an estimated distance of said principal object as viewed from said lens system according to a focal length of said lens system and an image size of said principal object;
a moving distance determiner for determining a lens moving distance of said focus lens from a lens position of infinity focus according to said estimated distance;
a lens moving mechanism for moving said focus lens by said lens moving distance in autofocus evaluation from said lens position of said infinity focus toward a lens position of close focus;
a contrast acquisition unit for acquiring a contrast value of said image from said image signal for lens positions in moving said focus lens; and
a focusing control unit for determining a lens position at a peak of said contrast value as in-focus lens position, to set said focus lens in said in-focus lens position.

2. An image pickup apparatus as defined in claim 1, wherein said principal object is a human face.

3. An image pickup apparatus as defined in claim 2, further comprising a corrector for correction of said estimated distance with a distance error created in estimation in said distance estimating unit, to determine said lens moving distance.

4. An image pickup apparatus as defined in claim 3, wherein if a plurality of principal objects are detected by said detection unit, said distance estimating unit determines said estimated distance to one of said principal objects with a largest size.

5. An image pickup apparatus as defined in claim 4, further comprising:
an aperture stop mechanism disposed on an optical axis of said lens system; and
an aperture stop adjuster for setting an aperture value of said aperture stop mechanism to enlarge a depth of field in detection of said principal object with said detection unit.

6. An image pickup apparatus as defined in claim 5, further comprising a sensitivity adjuster for setting ISO sensitivity of imaging according to a difference of said aperture value from an aperture value for optimizing an exposure.

7. An image pickup apparatus as defined in claim 1, wherein if said contrast value comes to a peak in plural lens positions of said focus lens, said focusing control unit determines one of said lens positions nearer to said lens position of said close focus as said in-focus lens position.

8. An image pickup apparatus as defined in claim 4, further comprising:
an aperture stop mechanism disposed on an optical axis of said lens system;
an object distance detector for determining a principal object distance and an auxiliary object distance according to first and second lens positions, said first lens position being associated with said principal object and defined at a peak of said contrast value in said lens moving distance, said second lens position being associated with an auxiliary object and defined at a peak of said contrast value on a side nearer to said lens position of said infinity focus than said first lens position;
an aperture value acquisition unit for acquiring an aperture value of said aperture stop mechanism to cause said auxiliary object to fall within a depth of field when said focus lens is set in said first lens position for said in-focus lens position according to said principal and auxiliary object distances; and
an aperture stop adjuster for adjusting said aperture stop mechanism according to said aperture value.

9. An image pickup apparatus as defined in claim 8, further comprising a sensitivity adjuster for setting ISO sensitivity of imaging according to a difference of said aperture value from an aperture value for optimizing an exposure.

10. An image pickup apparatus as defined in claim 4, further comprising:
an object distance detector for determining a principal object distance and an auxiliary object distance according to first and second lens positions, said first lens position being associated with said principal object and defined at a peak of said contrast value in said lens moving distance, said second lens position being associated with an auxiliary object and defined at a peak of said contrast value on a side nearer to said lens position of said infinity focus than said first lens position;
an in-focus position determiner for determining a corrected lens position of said focus lens to cause said principal and auxiliary object distances to fall within a depth of field, wherein said focusing control unit sets said focus lens in said corrected lens position as said in-focus lens position.

11. An image pickup apparatus as defined in claim 10, wherein if said lens moving distance is more than a half of a distance between said lens position of said infinity focus and said lens position of said close focus, said lens moving mechanism moves said focus lens from said lens position of said close focus toward said lens position of said infinity focus.

12. An image pickup apparatus comprising:
a lens system having a focus lens;
an image sensor for picking up an image formed by said lens system to generate an image signal by conversion;
a detection unit for detecting a principal object by image analysis according to said image signal;
an aperture stop mechanism disposed on an optical axis of said lens system; and
an aperture stop adjuster for setting an aperture value of said aperture stop mechanism to cause said principal object to fall within a depth of field.

13. An image pickup apparatus as defined in claim 12, further comprising a sensitivity adjuster for setting ISO sensitivity of imaging according to a difference of said aperture value from an aperture value for optimizing an exposure.

14. A focusing control method comprising steps of:
picking up an image formed by a lens system having a focus lens;
detecting a principal object in said image by image analysis thereof;
determining an estimated distance of said principal object as viewed from said lens system according to an image size of said principal object;
determining a lens moving distance of said focus lens according to said estimated distance;
moving said focus lens by said lens moving distance in autofocus evaluation from a lens position of infinity focus toward a lens position of close focus;
acquiring a contrast value of said image for lens positions in said autofocus evaluation; and
determining a lens position at a peak of said contrast value as in-focus lens position, to set said focus lens in said in-focus lens position.

15. A focusing control method as defined in claim 14, wherein said principal object is a human face.

16. A focusing control method as defined in claim 15, wherein if a plurality of principal objects are detected, said estimated distance to one of said principal objects with a largest size is determined in said estimated distance determining step.

17. A focusing control method as defined in claim 15, further comprising steps of:
determining a principal object distance and an auxiliary object distance according to first and second lens positions, said first lens position being associated with said principal object and defined at a peak of said contrast value in said lens moving distance, said second lens position being associated with an auxiliary object and defined at a peak of said contrast value on a side nearer to said lens position of said infinity focus than said first lens position;
acquiring an aperture value of said aperture stop mechanism to cause said auxiliary object to fall within a depth of field when said focus lens is set in said first lens position for said in-focus lens position according to said principal and auxiliary object distances; and
adjusting said aperture stop mechanism according to said aperture value.

18. A focusing control method as defined in claim 15, further comprising steps of:
determining a principal object distance and an auxiliary object distance according to first and second lens positions, said first lens position being associated with said principal object and defined at a peak of said contrast value in said lens moving distance, said second lens position being associated with an auxiliary object and defined at a peak of said contrast value on a side nearer to said lens position of said infinity focus than said first lens position;
determining a corrected lens position of said focus lens to cause said principal and auxiliary object distances to fall within a depth of field, to set said focus lens in said corrected lens position as said in-focus lens position.

19. A focusing control method as defined in claim 15, wherein if said lens moving distance is more than a half of a distance between said lens position of said infinity focus and said lens position of said close focus, then in said step of moving said focus lens, said focus lens is moved from said lens position of said close focus toward said lens position of said infinity focus.

20. A principal object detecting method of detecting a principal object in an image, comprising steps of:
picking up said image through a lens system; and
setting an aperture value for image pickup to enlarge a depth of field for said principal object.

21. A principal object detecting method as defined in claim 20, further comprising a step of setting ISO sensitivity of imaging according to a difference of said aperture value from an aperture value for optimizing an exposure.
